(19) United States
(12) Patent Application Publication
(10) Pub. No.: US 2024/0126680 A1
(43) Pub. Date: Apr. 18, 2024

(54) Apparatuses, Devices, Methods and Computer Programs for Allocating Memory

(71) Applicants: David KEPPEL, Mountain View, CA (US); David OZOG, Ashland, MA (US); Lawrence STEWART, Wayland, MA (US); Sri Raj PAUL, Austin, TX (US); Md RAHMAN, Bee Cave, TX (US)

(72) Inventors: David KEPPEL, Mountain View, CA (US); David OZOG, Ashland, MA (US); Lawrence STEWART, Wayland, MA (US); Sri Raj PAUL, Austin, TX (US); Md RAHMAN, Bee Cave, TX (US)

(21) Appl. No.: 18/391,714

(22) Filed: Dec. 21, 2023

(51) Int. Cl. G06F 12/02

(52) U.S. Cl. CPC G06F 12/0223

(57) ABSTRACT

Various examples relate to apparatuses, devices, methods and computer programs for allocating memory. An apparatus comprises interface circuitry, machine-readable instructions, and processor circuitry to execute the machine-readable instructions to process instructions of a software application of a local processing element participating in a partitioned global address space, allocate, upon processing an instruction for allocating memory on a symmetric heap being used across a plurality of processing elements participating in the partitioned global address space, memory on the symmetric heap, wherein, if the instruction for allocating memory indicates that memory is to be allocated with a variable size, the memory allocated on the symmetric heap has a size that is specific for the local processing element.

### STATEMENT OF GOVERNMENT INTEREST

This proposed concept was made with Government support under Agreement No. H98230-22-C-0260, awarded by Department of Defense. The Government has certain rights in the invention.

### BACKGROUND

“PGAS” or “Partitioned Global Address Space” is one way to distribute a large data set across many processing elements (PEs). PGAS-based programming models such as OpenSHMEM often use a so-called “symmetric heap” which is used to allocate remotely accessible data objects. In OpenSHMEM, the symmetric heap is the same size on every PE, but perhaps at a different address, and every PE's symmetric heap will contain the same objects with the same sizes and types. Allocation of an object in the symmetric heap is a collective operation and must be called on every PE with the same requested size. The purpose of this is to permit a PE to make remote memory accesses to objects on other PEs by using the PE number of the remote PE plus the local address of the same object. However, for some applications, varying-size allocation may be an advantage. As an example, it is common that PEs are clustered in “nodes” using a mid-size shared memory per node. In such design, saving memory for one PE means more memory is available for other PEs in the same node. Currently, in OpenSHMEM, there is no API that provides this ability while retaining the advantages provided by symmetric addressing.

Other programming models, such as MPI (Message Passing Interface), provide remotely accessible memory objects of different sizes on different ranks (rank is the MPI term for PE). In these implementations, the respective applications exchange the addresses of remote objects, and the runtime system is tasked with setting up and tearing down memory registration, at a substantial performance cost for small transfers that adversely affects programmability. The application may be written to exchange addresses of objects which are to be remotely accessible and to allocate and manage storage to save those addresses. The communication runtime for remote memory access may dynamically register memory for Remote Direct Memory Access (MPI) or cache those registrations (see Bell et al: “Firehose: An Algorithm for Distributed Page Registration on Clusters of SMPs”). Dynamic memory registration is expensive, which can make Remote Direct Memory Access (RDMA) too costly for small transfers.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device, and of a computer system comprising such an apparatus or device;

FIG. 1b shows a flow chart of an example of a method;

FIG. 2a shows a schematic diagram of an example of an apparatus or device, and of a computer system comprising such an apparatus or device;

FIG. 2b shows a flow chart of an example of a method;

FIG. 3 shows a schematic diagram of a memory allocation practice in OpenSHMEM;

FIG. 4 shows a schematic diagram of an example of variable size memory allocation in OpenSHMEM;

FIG. 5 shows a schematic diagram of an example of single PE allocation in OpenSHMEM; and

FIG. 6 shows a schematic diagram of an example of a memory layout for different PEs.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

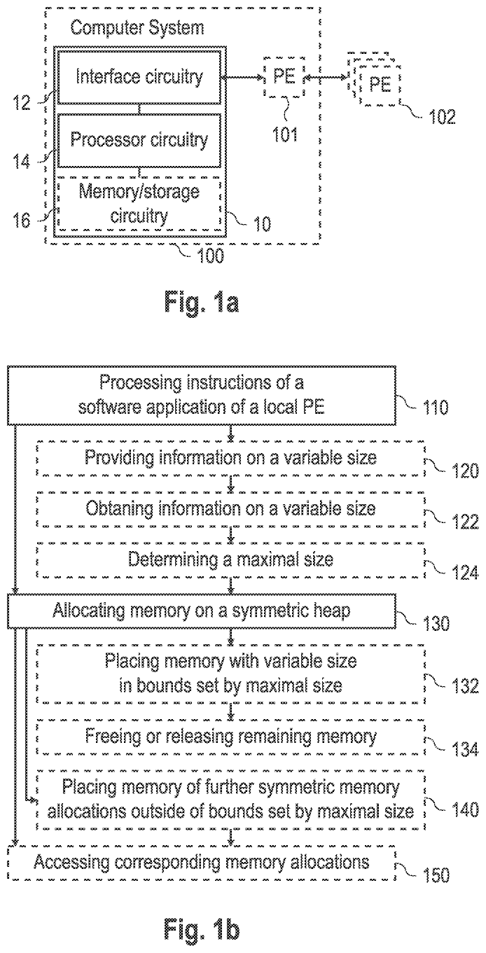

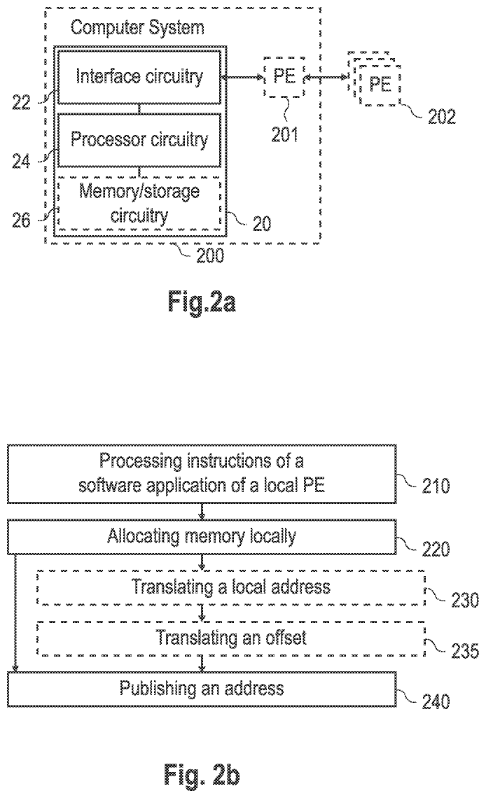

FIG. 1a shows a schematic diagram of an example of an apparatus 10 or device 10, and of a computer system 100 comprising such an apparatus 10 or device 10. In some examples, the computer system 100 may further comprise the apparatus 20 or device 20 shown in FIG. 2a, or the apparatus 10 or device 10 of FIG. 1a may further provide the functionality of the apparatus or device 20 shown in FIG. 2a. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processor circuitry 14, and (optional) memory/storage circuitry 16. For example, the processor circuitry 14 may be coupled with the interface circuitry 12 and/or with the memory/storage circuitry 16. For example, the processor circuitry 14 may provide the functionality of the apparatus, in conjunction with the interface circuitry 12 (for communicating with other entities inside or outside the computer system 100, such as with a local PE or one or more further PEs), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory or storage circuitry 16 or means for storing information 16.

The processor circuitry 14 or means for processing 14 is to process instructions of a software application of a local processing element 101 participating in a partitioned global address space. The processor circuitry 14 or means for processing 14 is to allocate, upon processing an instruction for allocating memory on a symmetric heap being used across a plurality of processing elements 101, 102 participating in the partitioned global address space, memory on the symmetric heap. If the instruction for allocating memory indicates that memory is to be allocated with a variable size, the memory allocated on the symmetric heap has a size that is specific for the local processing element.

FIG. 1b shows a flow chart of an example of a corresponding method. The method comprises processing 110 the instructions of the software application of the local processing element participating in the partitioned global address space. The method comprises allocating 130, upon processing an instruction for allocating memory on a symmetric heap being used across the plurality of processing elements participating in the partitioned global address space, the memory on the symmetric heap. If the instruction for allocating memory indicates that memory is to be allocated with a variable size, the memory allocated on the symmetric heap has a size that is specific for the local processing element. For example, the method may be performed by the computer system 100, e.g., by the apparatus 10 or device 10 of the computer system 100.

In the following, the functionality of the apparatus 10, device 10, method and of a corresponding computer program will be discussed in greater detail with reference to the apparatus 10. Features introduced in connection with the apparatus 10 may likewise be included in the corresponding device 10, method and computer program. Similarly, features introduced in connection with the apparatus 10 may likewise be included in the apparatus 20, device 20, method and computer program discussed in connection with FIGS. 2a and 2b.

The present disclosure relates to memory allocation in the context of a system comprising a plurality of processing elements (PE) that participate in a partitioned global address space (PGAS). A Partitioned Global Address Space (PGAS) is a programming model used in parallel computing which assumes a globally accessible address space that is logically divided such that a specific portion of it is local to each process (usually referred to as a “processing element” or PE). Different portions of the address space are distributed across different processing elements, which may be threads, cores, CPUs (Central Processing Units), or separate nodes in a cluster or a supercomputer, depending on the architecture and scale of the system. Accordingly, while the local PE is executed on the computer system 100, the remaining PEs of the plurality of PEs participating in the PGAS may be executed by other computer systems (i.e., nodes) or by the same computer system 100. The main feature of PGAS is that while it provides a shared global address memory space to simplify programming, it maintains the concept of data locality, allowing for efficient access patterns. The PGAS takes advantage of local memory being (usually) faster than accessing remote memory, while retaining the flexibility of a shared memory space for ease of programming. PGAS is popular in high-performance computing and can be found in programming languages and models such as Unified Parallel C (UPC), Co-array Fortran, Chapel, X10, (Open)SHMEM and others. While the present disclosure primarily relates to OpenSHMEM (i.e., communication among the plurality of processing elements may be conducted according to the OpenSHMEM protocol) the same concept is applicable to other programming languages and models as well.

In general, each processing element can directly access memory that is locally partitioned for it as if it were accessing regular shared memory, which is fast and efficient because it does not involve network communication or delays associated with memory access on remote nodes. In addition, processing elements can read from or write to memory locations that are part of another processing element's local space. This is typically done via one-sided communication primitives, such as ‘put’ to write data to a remote memory location, and ‘get’ to read data from a remote memory location. These operations may be implemented in a way that does not require involvement of the remote CPU, allowing for efficient data transfer.

A portion of the PGAS, —the global address space—can be directly accessed by all processes. A symmetric heap is a region of memory within this global address space that is partitioned among processes, where each partition is of the same size and has the same starting address within the local address space relative to a base address of the symmetric heap. The symmetric heap on each PE may have a different local starting address. Objects within the symmetric heap have instances on each PE, and each one will have the same offset within the symmetric heap but may have a different local address. In addition, the overall local address space of the process on each PE may be at different addresses as well. This is a security mechanism called “Address Space Layout Randomization”. In the approach discussed in connection with FIGS. 1a and 1b, this symmetric heap (i.e., the symmetric heap being used across the plurality of PEs participating in the PGAS) is adapted to support memory allocations with variable sizes while maintaining a symmetric layout.

The process starts by the processor circuitry 14 processing and executing (or interpreting), the instructions of the software application of the local processing element 101 participating in the PGAS. This software application may be the software application defining the processing element, i.e., the software application implementing the processing element at the computer system 100. When the processor circuitry 14 encounters an instruction for allocating memory on the symmetric heap, two options are possible, depending on the instruction. As a default, the memory allocated on the symmetric heap has a fixed size specified by the instruction, thus resulting in the symmetric property of the symmetric heap. If, however, the instruction for allocating memory indicates that memory is to be allocated with a variable size, the memory used/allocated on the symmetric heap has a size that is specific for the local processing element (e.g., with a variable size between 0 bits and the maximal size for the memory allocation). The instruction for allocating memory on the symmetric heap is a so-called “collective operation”. This means the allocation instruction is called by all PEs. In the fixed size case, the instruction calls for the same size object on every PE. In the variable size case, each PE may request a different size, according to its own requirements. The “maximal size” is the maximum over all the individual sizes requested by different PEs. The maximal size can be included in the instruction, or the system can figure it out by comparing the variable sizes from each PE.

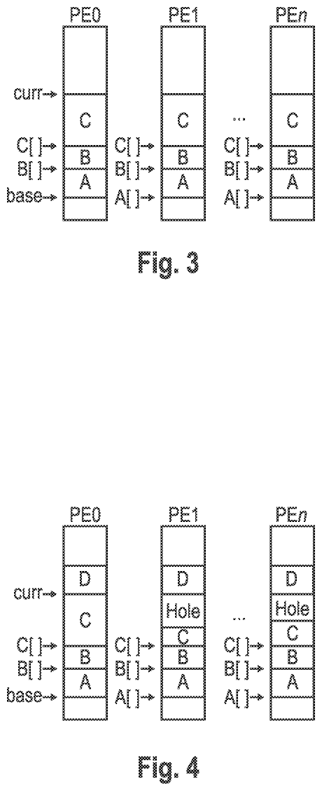

While the default case is shown in FIG. 3, where the allocations A[ ], B[ ] and C[ ] on the symmetric heap all have the same size across PEs PE0, PE1 . . . PEn, the variable size-case is shown in FIG. 4, where allocation C[ ] is a variable memory allocation. In this case, while the memory layout of the symmetric help remains symmetrical, some of the PEs (PE1 and PEn) locally only use a portion of the maximal size for the memory allocation. However, to maintain symmetry between PEs, the memory layout of the symmetric heap is done according to a maximal size required for the memory allocation. In other words, if the instruction for allocating memory indicates that memory is to be allocated with a variable size, the memory may be placed inside the symmetric heap according to a maximal size for the memory allocation. As shown in FIG. 4, this adherence to the maximal size for the memory allocation ensures that further symmetric memory allocations on the symmetric heap (e.g., allocation D[ ] in FIG. 4) again start at the same address relative to the base address. As a result, further symmetric memory allocations stay outside the bounds set by the maximal size of the variable memory allocation. In other words, the processor circuitry may place memory of one or more further symmetric memory allocations on the symmetric heap outside of bounds set by the maximal size for the memory allocation (having the variable size). Accordingly, as further shown in FIG. 1b, the method may comprise placing 140 memory of one or more further symmetric memory allocations on the symmetric heap outside of bounds set by the maximal size for the memory allocation. In particular, further symmetric memory allocation(s) might not be placed inside the bounds set by the maximal size for the memory allocation, as this would results in conflicts in PEs using the maximal size for the variable memory allocation.

The actual memory being used by the local PE 101 is placed into the bounds defined by the maximal size of the memory allocation, as also shown in FIG. 4. The processor circuitry may place the memory with the variable size within the bounds set by the maximal size for the memory allocation. Accordingly, as shown in FIG. 1b, the method may comprise placing 132 the memory with the variable size within the bounds set by the maximal size for the memory allocation. In PE0, PE1 and PEn of FIG. 4, the memory is placed at the beginning (i.e., the lowest address) of the bounds set by the maximal size for the memory allocation, with the remainder staying empty (the “hole” shown in PE1 and PEn). This “hole” may be used otherwise for local memory allocations or be released/freed by the operating system of the computer system. In other words, the processor circuitry may free or release remaining memory (i.e., memory not being used for the memory allocation with the variable size) within the bounds set by the maximal size of the memory allocation. Accordingly, as further shown in FIG. 1b, the method may comprise freeing or releasing 134 remaining memory not being used for the memory allocation with the variable size within the bounds set by the maximal size of the memory allocation. Alternatively, or additionally, the local PE may place objects unrelated to the PGAS in the “holes”, place “one PE” allocations (discussed in connection with FIGS. 2a, 2b, 5 and 6) in such holes to take advantage of the fact that such locations are remotely accessible. Finally, in an edge case scenario, PEs may place a symmetric variable size allocation in such holes provided that the PEs previously requesting the maximal size now happens to request a zero size. While such an allocation is complicated to organize, it is technically possible. This sort of second variable size allocation may overlap the first variable size allocation, but only in a way that the overlap is performed safely.

In the above description, the layout of the symmetric heap is defined by the maximal size for the memory allocation. In some examples, this maximal size may be defined statically as part of the software application. This is the case, if, for example, the instruction shmem_malloc_varsize(size, max) is used, which is discussed in connection with FIG. 4. For example, if the instruction for allocating memory indicates that memory is to be allocated with a variable size, the instruction for allocating memory may include information on the maximal size for the memory allocation. This option has the advantage that the overhead for performing the symmetric memory allocation, which is performed by (all of) the PEs participating in the PGAS is kept low. However, to ensure that the maximal size is set adequately, the PEs can coordinate the maximal size for the allocation amongst themselves at runtime through communication. For example, this may be the case if the instructions shmem_malloc_varsize(size) or shmem_malloc_varsize(in=size, out=sizes[ ]) are used. For example, the processor circuitry may obtain information on a maximal size being used for the memory allocation by the further processing elements from the further processing elements, and to determine the maximal size for the memory allocation based on the information on the maximal size used by the further processing elements. Accordingly, as further shown in FIG. 1b, the method may comprise obtaining 122 the information on a maximal size being used for the memory allocation by the further processing elements from the further processing elements and determining 124 the maximal size for the memory allocation based on the information on the maximal size used by the further processing elements. To coordinate the maximal size amongst the PEs, each PE may provide information on the variable size used by the respective PE to the other PEs. In other words, the processor circuitry may provide information on the variable size to further processing elements participating in the partitioned global address space. Accordingly, as further shown in FIG. 1b, the method may comprise providing 120 the information on the variable size to the further processing elements participating in the partitioned global address space. Similarly, each PE may receive the information on the variable sizes used by the further PEs from the further PEs. In other words, the processor circuitry may obtain information of variable sizes used by the further processing elements from the further processing elements. Accordingly, as further shown in FIG. 1b, the method may comprise obtaining 122 the information of the variable sizes used by the further processing elements from the further processing elements. For example, the information of the variable sizes used by the further processing elements may be collected through the sizes[ ] variable of the shmem_malloc_varsize(in=size, out=sizes[ ]) operation. This information may be used as, or to determine the, maximal size for the memory allocation based on the information on the maximal size used by the further processing elements (which is the maximal size among the variable sizes used by the local PE and by the further PEs).

As the symmetric heap still has a symmetric memory layout, accessing the memory of other PEs can be done as usual according to the symmetric memory layout of the symmetric heap. The processor circuitry may access corresponding memory allocations having a variable size of further processing elements of the plurality of processing elements participating in the partitioned global address space according to a global (i.e., symmetric) memory layout of the symmetric heap. Accordingly, the method may comprise accessing 150 corresponding memory allocations having a variable size of further processing elements of the plurality of processing elements participating in the partitioned global address space according to the global memory layout of the symmetric heap. As holes may exist locally at the different PEs, care may be taken not to trigger accessing freed/released memory. For this purpose, the information of the variable sizes used by the further processing elements may be used as well. In other words, the corresponding memory allocations having the variable size may be accessed according to the information of the variable sizes used by the further processing elements, e.g., to avoid accessing memory that is not used locally or used for a different purpose at the respective processing element(s).

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 10, device 10, computer system 100, method and computer program are mentioned in connection with the proposed concept, or one or more examples described above or below (e.g., FIGS. 2a to 6). The apparatus 10, device 10, computer system 100, method and computer program may comprise one or more additional optional features corresponding to one or more aspects of the proposed concept, or one or more examples described above or below.

FIG. 2a shows a schematic diagram of an example of an apparatus 20 or device 20, and of a computer system 20 comprising such an apparatus 20 or device 20. The apparatus 20 comprises circuitry to provide the functionality of the apparatus 20. For example, the circuitry of the apparatus 20 may be configured to provide the functionality of the apparatus 20. For example, the apparatus 20 of FIG. 2a comprises interface circuitry 22, processor circuitry 24, and (optional) memory/storage circuitry 26. For example, the processor circuitry 24 may be coupled with the interface circuitry 22 and/or with the memory/storage circuitry 26. For example, the processor circuitry 24 may provide the functionality of the apparatus, in conjunction with the interface circuitry 22 (for communicating with other entities inside or outside the computer system 200, such as with a local PE or one or more further PEs), and the memory/storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIG. 2a comprises means for processing 24, which may correspond to or be implemented by the processor circuitry 24, means for communicating 22, which may correspond to or be implemented by the interface circuitry 22, (optional) means for storing information 26, which may correspond to or be implemented by the memory or storage circuitry 26. In general, the functionality of the processor circuitry 24 or means for processing 24 may be implemented by the processor circuitry 24 or means for processing 24 executing machine-readable instructions. Accordingly, any feature ascribed to the processor circuitry 24 or means for processing 24 may be defined by one or more instructions of a plurality of machine-readable instructions. The apparatus 20 or device 20 may comprise the machine-readable instructions, e.g., within the memory or storage circuitry 26 or means for storing information 26.

The processor circuitry 24 or means for processing 24 is to process instructions of a software application of a local processing element 201 participating in a partitioned global address space. The processor circuitry 24 or means for processing 24 is to allocate, upon processing an instruction for allocating memory locally, the memory locally. The processor circuitry 24 or means for processing 24 is to publish an address of the local memory allocation for other processing elements 202 participating in the partitioned global address space.

FIG. 2b shows a flow chart of an example of a corresponding method. The method comprises processing 210 the instructions of the software application of the local processing element participating in the partitioned global address space. The method comprises allocating 220, upon processing an instruction for allocating memory locally, the memory locally. The method comprises publishing 240 the address of the local memory allocation for the other processing elements participating in the partitioned global address space. For example, the method may be performed by the computer system 200, e.g., by the apparatus 20 or device 20 of the computer system 200, and/or by the computer system 100, e.g., by the apparatus 10 or device of the computer system 100 shown in FIG. 1a.

In the following, the functionality of the apparatus 20, device 20, method and of a corresponding computer program will be discussed in greater detail with reference to the apparatus 20. Features introduced in connection with the apparatus 20 may likewise be included in the corresponding device 20, method and computer program. Similarly, features introduced in connection with the apparatus 20 may likewise be included in the apparatus 10, device 10, method and computer program discussed in connection with FIGS. 1a and 1b.

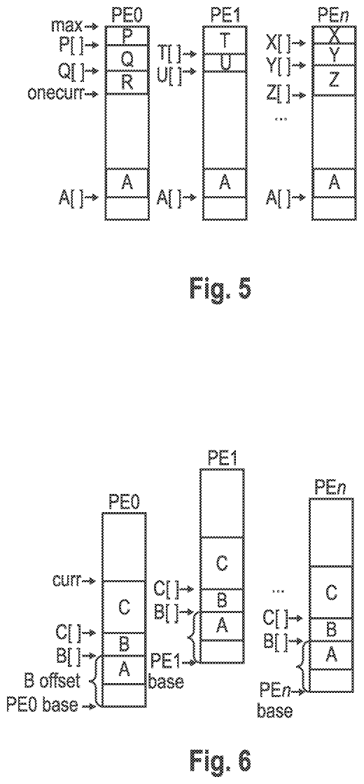

While FIGS. 1a and 1b relate to an approach for variable size memory allocations on the symmetric heap, FIGS. 2a and 2b provide an alternative approach, in which the memory is allocated locally at the local PE while providing a mechanism (as an alternative mechanism to using the symmetric heap) for other PEs to access the memory, by publishing the address of the local memory allocations for the other processing elements 202. However, the local memory allocation may be placed (preferably) inside (e.g., inside holes left by the technique discussed in connection with FIGS. 1a and 1b) or outside the symmetric heap. In connection with FIGS. 5 and 6, this approach is denoted “One PE” memory allocation and implemented by the shmem_malloc_onepe(size) instruction. Publishing may be implemented by the shmem_address_translate( . . . ) instruction or by a corresponding pointer operation, such as shmem_ptrdiff_of_ptr( . . . ), in combination with a put( ) operation. In a preferred example, the OnePE allocations may be placed inside the local symmetric heap, in regions that will not be used by regular symmetric allocations. This permits remote access to these objects because the entire symmetric heap is automatically registered for RDMA. If OnePE objects are allocated outside the symmetric heap, memory registration may be arranged for such regions as well as providing the address translations.

Contrary to the use of a symmetric memory heap, where access to the global memory is done based on the known memory layout of the symmetric heap, the approach discussed in connection with FIGS. 2a and 2b requires additional effort for publishing the addresses to be used for accessing the locally allocated memory from other PEs. Thus, the process includes at least two operations—allocating the memory locally and publishing the address of the local memory allocation for the other processing elements 202 participating in the partitioned global address space. For example, publishing can be done by an instruction that is similar to a put( ) instruction, which can be used to write the address to the respective other PEs that should gain access to the local memory allocation.

One benefit of using a symmetric memory heap is the implicit address management. In the more manual process discussed in connection with FIGS. 2a and 2b, operations may be performed to ensure that the respective other processing elements can use the published address to access the locally allocated memory. For this reason, the processor circuitry may translate a local address of the local memory allocation to generate remotely accessible addresses for the other processing elements, and to publish the remotely accessible addresses for the other processing elements (e.g., separately at each of the other processing elements, using a put( )-like operation). Accordingly, as further shown in FIG. 2b, the method may comprise translating 230, 235 the local address of the local memory allocation to generate remotely accessible addresses for the other processing elements and publishing 240 the remotely accessible addresses for the other processing elements. In particular, the processor circuitry may translate the local address of the local memory allocation into an offset of the local memory allocation relative to a base address of the local processing element. Accordingly, the method may comprise translating 230 the local address of the local memory allocation into the offset of the local memory allocation relative to a base address of the local processing element. This offset may then be translated into the address space used by the respective other processing elements, either by the local processing element or by the respective other processing element. In the former case, the processor circuitry may translate the offset into the remotely accessible addresses based on the address spaces used by the other processing elements. Accordingly, the method may comprise translating 235 the offset into the remotely accessible addresses based on the address spaces used by the other processing elements. To give an example, shown in FIG. 6, in which the local memory allocation B of PE0 (as local PE) is to be shared with PE1 (as other PE), first the offset between PE0's local address for B and the base address is calculated, and then PE1's address for B is calculated based on the base address (of the symmetric heap in the example of FIG. 6) of PE1 and the offset.

offset=(PE0's B address)−(PE0 base)

(PE1's B address)=(PE1 base)+offset

Please note that this example relates to a simplified example using a symmetric heap, in which the offset for B from the respective base address is the same across the PEs. Using the base address of the symmetric heap is a preferred example. In general, the proposed concept works even if the OnePE allocation is not within the symmetric heap. However, in this case, additional work is to be done for RDMA registration.

Another option is to use pointers (e.g., using a new voidstar datatype for remote pointers with a put( ) operation) e.g., pointer differences (e.g., using the ptrdiff_t datatype with a put( ) operation). ptrdiff_t is a type defined in the C standard library header <stddef.h>. ptrdiff_t is a signed integer type that is capable of storing the difference between two pointers. For example, the processor circuitry may publish a pointer to a local address of the local memory allocation, e.g., a pointer difference of a local address of the local memory allocation (relative to a base address, e.g., of the symmetric heap) for the other processing elements participating in the partitioned global address space. Accordingly, the method may comprise publishing 240 the pointer to the local address of the local memory allocation, e.g., the pointer difference of the local address of the local memory allocation relative to a base address for the other processing elements participating in the partitioned global address space.

The above address translation mechanism may not be required as the pointer difference is sufficient to get the translated address for a remote object. For example, as outlined in connection with FIG. 6, the following extensions may be used:

ptrdiff_t shmem_ptrdiff_of_ptr(void*ptr)

void*shmem_ptr_of_ptrdiff(ptrdiff_t ptrdiff)

where, shmem_ptrdiff_of_ptr( ) puts the pointer difference of the shmem_malloc_onepe( ) allocated object in a symmetric variable. shmem_ptrdiff_of_ptr (ptr) looks like it has only one argument, because the other one is implicit, supplied by the runtime. Other PEs can use shmem_ptr_of_ptrdiff( ) to convert that local pointer to a location within its memory layout.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processor circuitry 24 or means for processing 24 may be implemented using one or more processing units, one or more processing devices, any means for processing, such as a processor, a computer or a programmable hardware component being operable with accordingly adapted software. In other words, the described function of the processor circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 26 or means for storing information 26 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 20, device 20, computer system 200, method and computer program are mentioned in connection with the proposed concept, or one or more examples described above or below (e.g., FIG. 1a to 1b, 3 to 6). The apparatus 20, device 20, computer system 200, method and computer program may comprise one or more additional optional features corresponding to one or more aspects of the proposed concept, or one or more examples described above or below.

Various examples of the present disclosure relate to concepts for symmetric addressing with asymmetric allocation.

In the present disclosure, two APIs are proposed to support variable allocation sizes across callers. The first variant, “shmem_malloc_varsize”, which has been discussed in connection with FIGS. 1a and 1b, allows each caller to specify a different size, while keeping the requirement that all callers must participate. The second variant, “shmem_malloc_onepe”, which has been discussed in connection with FIGS. 2a and 2b, creates a private local allocation for the calling PE.

Examples of the present disclosure are based on the finding, that using a symmetric heap obviates the need to exchange addresses of objects, since a PE uses its local address for the same object to do a remote access. The system retains the benefits of a symmetric heap by retaining the concept that every PE has a version of every object, but with the twist that each PE's object can be of different size. A PE will still use the local address of its version of an object when doing a remote access. In the case of shmem_malloc_onepe, it is still possible to preregister memory, even though it may be necessary to exchange object addresses.

With the first API, callers can allocate only what is needed per PE, thereby reducing the overall memory footprint for all the PEs. Although each PE may allocate different-size memory, the memory layout is the same for each PE, as with the prior existing “shmem_malloc/shmem_calloc” call. With the second API, all PEs are not required to participate and so does not require collective calls or synchronization. However, to make this allocation available for remote memory operations, this proposed concept proposes an address translation mechanism, through which a local allocation address can be used by other PEs, similar to allocations using the prior existing “shmem_malloc/shmem_calloc” call.

The features of this proposed concept can be used in PGAS programs that support use of a symmetric heap (e.g., OpenSHMEM), with variable size allocations requested from different PEs. In the OpenSHMEM programming standard, currently supported APIs allow to create a symmetric allocation is shmem_malloc(size). Using the proposed technique, different allocation sizes may be used on each PE (e.g., shmem_malloc_varsize(size) or similar) The returned allocated region may be used for SHMEM remote memory operations, such as shmem_put or shmem_get.

“PGAS” or “Partitioned Global Address Space” is one way to distribute a large data set across many small processing elements (PEs). PGAS typically uses a “symmetric heap”: with N PEs, each PE has 1/N of the data. Example systems using PGAS include SHMEM (see http://openshmem.org) and UPC/UPC++ (see https://upc.lbl.gov/). In more complex applications, it is desirable to make PEs do specialized tasks, so that one PE might maintain storage for most of the objects of one type, while another PE might maintain storage for most objects of another type. With symmetric allocation, it is usually necessary to allocate the maximum amount of space for every object type on every PE. With asymmetric size allocation, the total memory demand can be lessened because each PE need to have only enough memory for its own managed objects. Each PE may have at least a token allocation for each object type, to retain the access symmetry of the heap.

In SHMEM, at program launch time, each PE allocates a symmetric heap of the same overall size. The heaps on different PEs may be at different virtual addresses. During runtime, applications use shmem_malloc or shmem_calloc to allocate objects in the symmetric heap. The PEs call these allocation functions collectively (at the same time and with the same arguments) so all the symmetric heaps will have the same internal layout. This is what permits SHMEM to use a local address plus a PE number to read and write data in the remote PE. The SHMEM runtime system translates the local pointer into a valid remote pointer by using the base addresses of the different symmetric heaps. In addition, since the symmetric heap is allocated all-at-once at program start time, all the memory can be preregistered for Remote Direct Memory Access (RDMA), which makes individual RMA operations much faster.

For some applications, asymmetric allocation may be an advantage. For example, it is common that PEs are clustered in “nodes” using a mid-size shared memory processors per node (PPN). In this design, saving memory for one PE means more memory is available for other PEs in the same node.

Current symmetric heaps tie together two ideas: “memory allocation” and “memory addressing”. Regular addressing makes it easy to map from “address” to “which PE owns the storage”. For example, in a cyclic distribution, all PEs with the same value for floor(PE_number/PEs_per_node) are in the same node. However, PEs may have different memory needs. When allocation and addressing are tied, every PE allocates as much memory as the memory needed by the largest PE request. In turn, almost all PEs may be allocating some memory they do not need.

Asymmetric “allocation” means PEs with lower memory need can allocate less physical memory. In turn, that memory can be made available for PEs with higher memory need.

This disclosure covers two related approaches to asymmetric allocation: In a first approach, the PEs may all allocate memory, but each one a different amount. In a second approach, only one PE allocates memory, but it is still addressable from other PEs.

In the following, the first approach (“All PEs Allocation”) is discussed. In the current MPI/OpenSHMEM standard, the practice is to do a “collective” allocation operation, meaning all PEs call the routine. An example in OpenSHMEM is:

sto=shmem_malloc(size)

This allocates “size” bytes of physical memory for each PE. FIG. 3 presents a scenario where all the PEs make several calls to shmem_malloc ( ) in order to allocate arrays A[ ], B[ ], and C[ ] on the symmetric heap, starting from a base address up to a current address. FIG. 3 shows a schematic diagram of a memory allocation practice in OpenSHMEM.

Every PE receives a virtual address “st” which is local to the calling PE but combined with the PE number, other PEs can access the storage. For example, PE0 may call shmem_putmem(dst=&C[33], src, len, 1), which copies len bytes from PE0 to PE1, placing the data starting at &C[33] in PE1. The UPC/UPC++ memory model is different in detail, but the storage approach is similar.

This proposed concept offers an operation for allocating memory with a variable size:

sto=shmem_malloc_varsize(size,max)

where “size” is the size used by the current PE and “max” is the largest size used over all PEs. “size” may be zero for some of the PEs, but there may be some PEs where “size” is greater than zero. FIG. 4 shows a schematic diagram of an example of variable size memory allocation in OpenSHMEM. In this example, C[ ] is allocated with shmem_malloc_varsize ( ), and some PEs have size smaller than max, leaving a hole between the allocation for C[ ] and the next allocation D[ ]. This can return the same memory layout as the existing system in case of “size==max”. The existing interface requires every PE to allocate “max” physical memory, but this interface allows a PE to allocate as little as “size” physical memory.

In FIG. 4, PE1 has a large gap between the end of C[ ] and the start of some next allocation D[ ]. The allocator may return some of the storage to the operating system. In FIG. 4, the region [hole] might be some number of virtual memory pages. Some memory after C[ ] and before D[ ] might thus be allocated (and thus wasted) while other memory (in [hole]) is returned. This can co-operate with the operating system or other physical storage allocators, so the “unused” memory in one PE (max−size) is available for other PEs.

There may be several kinds of calls which are similar to the above. As a specific example:

sto=shmem_malloc_varsize(in=size,out=sizes[ ])

in which a PE requests “size” and gets two return values: the actual storage address “sto”, and “sizes” which says what is the size requested by other PEs. The function is equivalent to the earlier call except it provides the additional information of each PE's allocated size to the user.

Another variant of the same functionality is:

sto=shmem_malloc_varsize(size)

in which the user does not have to provide the “max” size, and the runtime can derive it as part of the collective memory allocation. But when the “max” size is provided, it provides more optimization opportunities such as if there are a bunch of back-to-back shmem_malloc_varsize operation, the collective operation can be postponed to the last shmem_malloc_varsize and all others can be local operations.

In the following, the second aspect (“Per PE Allocation”) is discussed. The prior section describes a collective operation where two or more PEs may allocate memory. In other words, “size” can be non-zero on two or more PEs. This section describes a related API, where only one PE allocates memory. However, the allocated memory should be remote accessible and maintain the current memory access properties in the programming model. As an example,

sto=shmem_malloc_onepe(size)

allocates “size” bytes of memory in the calling PE. FIG. 5 presents an example of such e mechanism where various allocations have been made on each PE. FIG. 5 shows a schematic diagram of an example of single PE allocation in OpenSHMEM. In PE0, R[ ], Q[ ] and P[ ], in P1 U[ ] and T[ ], and in PEn X[ ], Y[ ] and Z1 are allocated locally at the respective PE, while remaining accessible to the other PEs. The local storage management is similar to malloc( ) but unlike malloc( ) one-PE allocations are still “remotely accessible”. That is, they are allocated in memory which can be accessed using ordinary get( ) and put( ) operations, with the caller having to manually obtain an appropriate local address to use in the call to put or get.

One-PE allocation can be an advantage because it avoids synchronization across PEs. Both shmem_malloc( ) and shmem_malloc_varsize( ) are “collective” operations. That is, they require some or all PEs to make the call. Collective operations can require additional synchronization operations beyond the call itself.

In contrast, the “one PE” allocation is a local operation, so it can be faster. However, it gives rise to a new requirement: the local allocation is known only to the calling PE. Other PEs need to learn about the allocation before they can access it.

This mechanism is denoted “publishing”. Existing shmem_malloc ( ) does publishing as an implied operation because all participating PEs call shmem_malloc( ), which performs both allocation and publishing. That is, once PE0 knows the address of its local A[ ], it also knows how to operate on the A[ ]s of all other PEs.

shmem_malloc_onepe( ) is a local operation and uses an additional publishing operation. For example, the following does a local allocation and then uses shmem_address_translate( ) to publish the value to other PEs:

```
void *allocs[1]
allocs[0] = shmem_malloc_onepe(sz)
for penum in [0..npes):
    shmem_address_translate(dst=..., src=&allocs[0], len=1,
    dstpe=penum)
```

Here, shmem_address_translate( ) acts similar to a put operation but is different from other data communication operations. Most data (integer, unsigned, float, etc.) are interpreted the same on every PE. That is, an integer 0x1001 is “9” on every PE. In contrast, runtimes often allow that symmetric addresses can have different bit patterns on each PE, and so an address may be adjusted to make sense on each PE. FIG. 6 shows a schematic diagram of an example of a memory layout for different PEs. FIG. 6 shows an example layout on existing systems. Each symmetric region starts at a different address, but the layout is the same within a symmetric region. Thus, 13[ ] has a different virtual address in each PE, but the same offset from the start (base) of the symmetric region.

If PE0 calls shmem_put(dst=B, src=B, len, penum=1), then the runtime will use PE0's address for B to compute an offset from the start of the symmetric region, then use the PE1's symmetric region start and the offset to reconstitute the virtual address in PE1:

offset=(PE0's B address)−(PE0 base)

(PE1's B address)=(PE1 base)+offset

In this way, each PE can have a different VADDR map but using offsets can communicate location across PEs without a common addressing base. This is common in most SHMEM implementations today.

The second aspect of the proposed concept builds on the above to construct shmem_address_translate( )—it may convert one PEs addresses into an offset, and then convert the offset back into the address space of the PE that wants to use it. This has the effect that one PE can call shmem_malloc_onepe ( ), then the address can be sent to another PE via shmem_address_translate( ), then the PE receiving it can use put( )/get( )/etc. using the address—just the same as it does for an address returned from the existing shmem_malloc ( ).

Further, this provides a way the implementation can place allocations, so a routine calling e.g., put( ) does not need to distinguish between allocations from shmem_malloc( ) and shmem_malloc_onepe( ). In other words, local shmem_malloc_onepe( ) allocation is treated by remote PEs the same as other allocations.

Thus, allocation is scalable: once a remote PE has a shmem_malloc_onepe( ) address, the remote PE may treat it the same as other addresses. That is, a remote PE can have shmem_malloc_onepe( ) allocations from many other PEs, but treats all of them the same, without any special-case handling. This means each remote PE's handling is scalable, for any number of PEs that may request shmem_malloc_onepe( ) allocation.

An alternative to shmem_address_translate( ) is to add a new data type such as voidstar, and to extend routines such as put( ) and get( ) to know about the voidstar type. For example, SHMEM today has put long ( ), put short ( ), put float( ), and so on. This can be extended with put_voidstar( ) to communicate addresses. This approach differs from other put( ) routines as described above in that it may update the address (if needed) on communication between PEs. A possible implementation similar to this can easily be achieved by using the ptrdiff_t data type, which provides an explicit format to move a pointer. The above address translation mechanism may not be required as the pointer difference is all the implementations will need to be passed around for an SHMEM object to get the translated address for a remote object. In this case, the following extensions are proposed:

ptrdiff_t shmem_ptrdiff_of_ptr(void*ptr)

void*shmem_ptr_of_ptrdiff(ptrdiff_t ptrdiff)

where, shmem_ptrdiff_of_ptr( ) puts the pointer difference of the shmem_malloc_onepe( ) allocated object in a symmetric variable. Other PEs can use shmem_ptr_of_ptrdiff( ) to convert that local pointer to a location within its memory layout. This mechanism works for any pointer values (e.g., in the symmetric heap or outside the symmetric heap). A remote PE can create a “local address” that may not point to anything on the remote PE, but which will be valid in a call to get or put to the PE from which the published address came. The only additional effort for using address translate or ptr to offset for addresses that are not in the symmetric heap is that the runtime has to make the address “remotely accessible” by going through, for example, the appropriate memory registration for it. The source PE for such a pointer can compute the ptrdiff version and store it in the symmetric heap or pass it around in any way. When the same or a different PE wishes to use it, it will be converted back to pointer form.

A shmem_malloc_onepe( ) allocator may be built on the shmem_malloc_varsize(sz, max) allocator. However, it can have several costs compared to the shmem_malloc_onepe( ) interface. First, shmem_malloc_varsize( ) uses collective participation. That can result in overhead not needed for shmem_malloc_onepe( ). Second, shmem_malloc_varsize( ) allocates addresses on all PEs, whereas addresses allocated by shmem_malloc_onepe( ) are further constrained by the specific PE. In turn, using shmem_malloc_varsize( ) with a single PE may allocate virtual addresses in a pattern which is hard to implement efficiently compared to shmem_malloc_onepe( ).

More details and aspects of the concepts for symmetric addressing with asymmetric allocation are mentioned in connection with the proposed concept, or one or more examples described above or below (e.g., FIG. 1a to 2b). The concepts for symmetric addressing with asymmetric allocation may comprise one or more additional optional features corresponding to one or more aspects of the proposed concept, or one or more examples described above or below.

In the following, some examples of the proposed concept are presented:

An example (e.g., example 1) relates to an apparatus (10) comprising interface circuitry (12), machine-readable instructions, and processor circuitry (14) to execute the machine-readable instructions to process instructions of a software application of a local processing element (101) participating in a partitioned global address space, allocate, upon processing an instruction for allocating memory on a symmetric heap being used across a plurality of processing elements (102) participating in the partitioned global address space, memory on the symmetric heap, wherein, if the instruction for allocating memory indicates that memory is to be allocated with a variable size, the memory allocated on the symmetric heap has a size that is specific for the local processing element.

Another example (e.g., example 2) relates to a previous example (e.g., example 1) or to any other example, further comprising that if the instruction for allocating memory indicates that memory is to be allocated with a variable size, the memory is placed inside the symmetric heap according to a maximal size for the memory allocation.

Another example (e.g., example 3) relates to a previous example (e.g., example 2) or to any other example, further comprising that the processor circuitry is to execute the machine-readable instructions to place memory of one or more further symmetric memory allocations on the symmetric heap outside of bounds set by the maximal size for the memory allocation.

Another example (e.g., example 4) relates to a previous example (e.g., one of the examples 2 or 3) or to any other example, further comprising that the processor circuitry is to execute the machine-readable instructions to place the memory with the variable size within bounds set by the maximal size for the memory allocation, and to free or release remaining memory not being used for the memory allocation with the variable size within the bounds set by the maximal size of the memory allocation.

Another example (e.g., example 5) relates to a previous example (e.g., one of the examples 2 to 4) or to any other example, further comprising that the memory is allocated with a variable size between 0 bits and the maximal size for the memory allocation.

Another example (e.g., example 6) relates to a previous example (e.g., one of the examples 2 to 5) or to any other example, further comprising that if the instruction for allocating memory indicates that memory is to be allocated with a variable size, the instruction for allocating memory includes information on the maximal size for the memory allocation.

Another example (e.g., example 7) relates to a previous example (e.g., one of the examples 1 to 6) or to any other example, further comprising that the processor circuitry is to execute the machine-readable instructions to provide information on the variable size to further processing elements participating in the partitioned global address space, and to obtain information of variable sizes used by the further processing elements from the further processing elements.

Another example (e.g., example 8) relates to a previous example (e.g., one of the examples 6 or 7) or to any other example, further comprising that the processor circuitry is to execute the machine-readable instructions to obtain information on a maximal size being used for the memory allocation by the further processing elements from the further processing elements, and to determine a maximal size for the memory allocation based on the information on the maximal size used by the further processing elements.

Another example (e.g., example 9) relates to a previous example (e.g., one of the examples 1 to 8) or to any other example, further comprising that the processor circuitry is to execute the machine-readable instructions to access corresponding memory allocations having a variable size of further processing elements of the plurality of processing elements participating in the partitioned global address space according to a global memory layout of the symmetric heap.

Another example (e.g., example 10) relates to a previous example (e.g., one of the examples 1 to 9) or to any other example, further comprising that communication among the plurality of processing elements is conducted according to the OpenSHMEM protocol.

An example (e.g., example 11) relates to an apparatus (20) comprising interface circuitry (22), machine-readable instructions, and processor circuitry (24) to execute the machine-readable instructions to process instructions of a software application of a local processing element (201) participating in a partitioned global address space, allocate, upon processing an instruction for allocating memory locally, the memory locally, and publish an address of the local memory allocation for other processing elements (202) participating in the partitioned global address space.

Another example (e.g., example 12) relates to a previous example (e.g., example 11) or to any other example, further comprising that the processor circuitry is to execute the machine-readable instructions to translate a local address of the local memory allocation to generate remotely accessible addresses for the other processing elements, and to publish the remotely accessible addresses for the other processing elements.

Another example (e.g., example 13) relates to a previous example (e.g., example 12) or to any other example, further comprising that the processor circuitry is to execute the machine-readable instructions to translate the local address of the local memory allocation into an offset of the local memory allocation relative to a base address of the local processing element.

Another example (e.g., example 14) relates to a previous example (e.g., one of the examples 12 or 13) or to any other example, further comprising that the processor circuitry is to execute the machine-readable instructions to translate the offset into the remotely accessible addresses based on the address spaces used by the other processing elements.

Another example (e.g., example 15) relates to a previous example (e.g., one of the examples 11 to 14) or to any other example, further comprising that the processor circuitry is to execute the machine-readable instructions to publish a pointer to a local address of the local memory allocation for the other processing elements participating in the partitioned global address space.

Another example (e.g., example 16) relates to a previous example (e.g., one of the examples 11 to 15) or to any other example, further comprising that the processor circuitry is to execute the machine-readable instructions to publish a pointer difference of a local address of the local memory allocation relative to a base address for the other processing elements participating in the partitioned global address space.

Another example (e.g., example 17) relates to a previous example (e.g., one of the examples 11 to 16) or to any other example, further comprising that communication among the processing elements is conducted according to the OpenSHMEM protocol.

An example (e.g., example 18) relates to an apparatus (10) comprising processor circuitry (14) configured to process instructions of a software application of a local processing element participating in a partitioned global address space, and allocate, upon processing an instruction for allocating memory on a symmetric heap being used across a plurality of processing elements participating in the partitioned global address space, memory on the symmetric heap, wherein, if the instruction for allocating memory indicates that memory is to be allocated with a variable size, the memory allocated on the symmetric heap has a size that is specific for the local processing element.

An example (e.g., example 19) relates to an apparatus (20) comprising processor circuitry (24) configured to process instructions of a software application of a local processing element participating in a partitioned global address space, allocate, upon processing an instruction for allocating memory locally, the memory locally, and publish an address of the local memory allocation for other processing elements participating in the partitioned global address space.

An example (e.g., example 20) relates to a device (10) comprising means for processing (14) for processing instructions of a software application of a local processing element participating in a partitioned global address space, and allocating, upon processing an instruction for allocating memory on a symmetric heap being used across a plurality of processing elements participating in the partitioned global address space, memory on the symmetric heap, wherein, if the instruction for allocating memory indicates that memory is to be allocated with a variable size, the memory allocated on the symmetric heap has a size that is specific for the local processing element.

An example (e.g., example 21) relates to a device (20) comprising means for processing (24) for processing instructions of a software application of a local processing element participating in a partitioned global address space, allocating, upon processing an instruction for allocating memory locally, the memory locally, and publishing an address of the local memory allocation for other processing elements participating in the partitioned global address space.

Another example (e.g., example 22) relates to a computer system (100, 200) comprising at least one apparatus (10, 20) or device (10, 20) according to one of the examples 1 to 21 (or according to any other example).

An example (e.g., example 23) relates to a method comprising processing (110) instructions of a software application of a local processing element participating in a partitioned global address space, and allocating (130), upon processing an instruction for allocating memory on a symmetric heap being used across a plurality of processing elements participating in the partitioned global address space, memory on the symmetric heap, wherein, if the instruction for allocating memory indicates that memory is to be allocated with a variable size, the memory allocated on the symmetric heap has a size that is specific for the local processing element.

Another example (e.g., example 24) relates to a previous example (e.g., example 23) or to any other example, further comprising that if the instruction for allocating memory indicates that memory is to be allocated with a variable size, the memory is placed inside the symmetric heap according to a maximal size for the memory allocation.

Another example (e.g., example 25) relates to a previous example (e.g., example 24) or to any other example, further comprising that the method comprises placing (140) memory of one or more further symmetric memory allocations on the symmetric heap outside of bounds set by the maximal size for the memory allocation.

Another example (e.g., example 26) relates to a previous example (e.g., one of the examples 24 or 25) or to any other example, further comprising that the method comprises placing (132) the memory with the variable size within bounds set by the maximal size for the memory allocation, and freeing or releasing (134) remaining memory not being used for the memory allocation with the variable size within the bounds set by the maximal size of the memory allocation.

Another example (e.g., example 27) relates to a previous example (e.g., one of the examples 24 to 26) or to any other example, further comprising that the memory is allocated with a variable size between 0 bits and the maximal size for the memory allocation.

Another example (e.g., example 28) relates to a previous example (e.g., one of the examples 24 to 27) or to any other example, further comprising that if the instruction for allocating memory indicates that memory is to be allocated with a variable size, the instruction for allocating memory includes information on the maximal size for the memory allocation.

Another example (e.g., example 29) relates to a previous example (e.g., one of the examples 23 to 28) or to any other example, further comprising that the method comprises providing (120) information on the variable size to further processing elements participating in the partitioned global address space and obtaining (122) information of variable sizes used by the further processing elements from the further processing elements.

Another example (e.g., example 30) relates to a previous example (e.g., one of the examples 28 or 29) or to any other example, further comprising that the method comprises obtaining (122) information on a maximal size being used for the memory allocation by the further processing elements from the further processing elements and determining (124) a maximal size for the memory allocation based on the information on the maximal size used by the further processing elements.

Another example (e.g., example 31) relates to a previous example (e.g., one of the examples 23 to 30) or to any other example, further comprising that the method comprises accessing (150) corresponding memory allocations having a variable size of further processing elements of the plurality of processing elements participating in the partitioned global address space according to a global memory layout of the symmetric heap.

Another example (e.g., example 32) relates to a previous example (e.g., one of the examples 23 to 31) or to any other example, further comprising that communication among the plurality of processing elements is conducted according to the OpenSHMEM protocol.

An example (e.g., example 33) relates to a method comprising processing (210) instructions of a software application of a local processing element participating in a partitioned global address space, allocating (220), upon processing an instruction for allocating memory locally, the memory locally, and publishing (240) an address of the local memory allocation for other processing elements participating in the partitioned global address space.

Another example (e.g., example 34) relates to a previous example (e.g., example 33) or to any other example, further comprising that the method comprises translating (230) a local address of the local memory allocation to generate remotely accessible addresses for the other processing elements, and publishing (240) the remotely accessible addresses for the other processing elements.

Another example (e.g., example 35) relates to a previous example (e.g., example 34) or to any other example, further comprising that the method comprises translating (230) the local address of the local memory allocation into an offset of the local memory allocation relative to a base address of the local processing element.

Another example (e.g., example 36) relates to a previous example (e.g., one of the examples 34 or 35) or to any other example, further comprising that the method comprises translating (235) the offset into the remotely accessible addresses based on the address spaces used by the other processing elements.

Another example (e.g., example 37) relates to a previous example (e.g., one of the examples 33 to 36) or to any other example, further comprising that the method comprises publishing (240) a pointer to a local address of the local memory allocation for the other processing elements participating in the partitioned global address space.

Another example (e.g., example 38) relates to a previous example (e.g., one of the examples 33 to 37) or to any other example, further comprising that the method comprises publishing (240) a pointer difference of a local address of the local memory allocation relative to a base address for the other processing elements participating in the partitioned global address space.

Another example (e.g., example 39) relates to a previous example (e.g., one of the examples 33 to 38) or to any other example, further comprising that communication among the processing elements is conducted according to the OpenSHMEM protocol.

Another example (e.g., example 40) relates to a computer system (100, 200) for performing at least one of the method of one of the examples 23 to 32 (or according to any other example) and the method of one of the examples 33 to 39 (or according to any other example).

Another example (e.g., example 41) relates to a non-transitory, computer-readable medium comprising a program code that, when the program code is executed on a processor, a computer, or a programmable hardware component, causes the processor, computer, or programmable hardware component to perform at least one of the method of one of the examples 23 to 32 (or according to any other example) and the method of one of the examples 33 to 39 (or according to any other example).

Another example (e.g., example 42) relates to a non-transitory machine-readable storage medium including program code, when executed, to cause a machine to perform at least one of the method of one of the examples 23 to 32 (or according to any other example) and the method of one of the examples 33 to 39 (or according to any other example).

Another example (e.g., example 43) relates to a computer program having a program code for performing at least one of the method of one of the examples 23 to 32 (or according to any other example) and the method of one of the examples 33 to 39 (or according to any other example) when the computer program is executed on a computer, a processor, or a programmable hardware component.

Another example (e.g., example 44) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions, and processor circuitry to execute the machine-readable instructions to:
process instructions of a software application of a local processing element participating in a partitioned global address space;
allocate, upon processing an instruction for allocating memory on a symmetric heap being used across a plurality of processing elements participating in the partitioned global address space, memory on the symmetric heap,
wherein, if the instruction for allocating memory indicates that memory is to be allocated with a variable size, the memory allocated on the symmetric heap has a size that is specific for the local processing element.

2. The apparatus according to claim 1, wherein, if the instruction for allocating memory indicates that memory is to be allocated with a variable size, the memory is placed inside the symmetric heap according to a maximal size for the memory allocation.

3. The apparatus according to claim 2, wherein the processor circuitry is to execute the machine-readable instructions to place memory of one or more further symmetric memory allocations on the symmetric heap outside of bounds set by the maximal size for the memory allocation.

4. The apparatus according to claim 2, wherein the processor circuitry is to execute the machine-readable instructions to place the memory with the variable size within bounds set by the maximal size for the memory allocation, and to free or release remaining memory not being used for the memory allocation with the variable size within the bounds set by the maximal size of the memory allocation.

5. The apparatus according to claim 2, wherein the memory is allocated with a variable size between 0 bits and the maximal size for the memory allocation.

6. The apparatus according to claim 2, wherein, if the instruction for allocating memory indicates that memory is to be allocated with a variable size, the instruction for allocating memory includes information on the maximal size for the memory allocation.

7. The apparatus according to claim 6, wherein the processor circuitry is to execute the machine-readable instructions to provide information on the variable size to further processing elements participating in the partitioned global address space, and to obtain information of variable sizes used by the further processing elements from the further processing elements.

8. The apparatus according to claim 6, wherein the processor circuitry is to execute the machine-readable instructions to obtain information on a maximal size being used for the memory allocation by the further processing elements from the further processing elements, and to determine a maximal size for the memory allocation based on the information on the maximal size used by the further processing elements.

9. The apparatus according to claim 1, wherein the processor circuitry is to execute the machine-readable instructions to access corresponding memory allocations having a variable size of further processing elements of the plurality of processing elements participating in the partitioned global address space according to a global memory layout of the symmetric heap.

10. The apparatus according to claim 1, wherein communication among the plurality of processing elements is conducted according to the OpenSHMEM protocol.

11. An apparatus comprising interface circuitry, machine-readable instructions, and processor circuitry to execute the machine-readable instructions to:
process instructions of a software application of a local processing element participating in a partitioned global address space;
allocate, upon processing an instruction for allocating memory locally, the memory locally; and
publish an address of the local memory allocation for other processing elements participating in the partitioned global address space.

12. The apparatus according to claim 11, wherein the processor circuitry is to execute the machine-readable instructions to translate a local address of the local memory allocation to generate remotely accessible addresses for the other processing elements, and to publish the remotely accessible addresses for the other processing elements.

13. The apparatus according to claim 12, wherein the processor circuitry is to execute the machine-readable instructions to translate the local address of the local memory allocation into an offset of the local memory allocation relative to a base address of the local processing element.

14. The apparatus according to claim 12, wherein the processor circuitry is to execute the machine-readable instructions to translate the offset into the remotely accessible addresses based on the address spaces used by the other processing elements.

15. The apparatus according to claim 11, wherein the processor circuitry is to execute the machine-readable instructions to publish a pointer to a local address of the local memory allocation for the other processing elements participating in the partitioned global address space.

16. The apparatus according to claim 11, wherein the processor circuitry is to execute the machine-readable instructions to publish a pointer difference of a local address of the local memory allocation relative to a base address for the other processing elements participating in the partitioned global address space.

17. The apparatus according to claim 11, wherein communication among the processing elements is conducted according to the OpenSHMEM protocol.

18. A method comprising:
processing instructions of a software application of a local processing element participating in a partitioned global address space; and
allocating, upon processing an instruction for allocating memory on a symmetric heap being used across a plurality of processing elements participating in the partitioned global address space, memory on the symmetric heap,
wherein, if the instruction for allocating memory indicates that memory is to be allocated with a variable size, the memory allocated on the symmetric heap has a size that is specific for the local processing element.

19. A non-transitory, computer-readable medium comprising a program code that, when the program code is executed on a processor, a computer, or a programmable hardware component, causes the processor, computer, or programmable hardware component to perform the method of claim 18.
